(19) United States
(12) Patent Application Publication
(10) Pub. No.: US 2003/0227934 A1
(43) Pub. Date: Dec. 11, 2003

(54) System and method for multicast media access using broadcast transmissions with multiple acknowledgements in an Ad-Hoc communications network

(76) Inventors: Eric D. White, Cedarburg, WI (US); Pertti O. Alapuranen, Melbourne, FL (US)

Correspondence Address: Joseph J. Buczynski, Roylance, Abrams, Berdo & Goodman, L.L.P., Suite 600, 1300 19th Street, N.W., Washington, DC, 20036, US

(21) Appl. No.: 10/457,539

(22) Filed: Jun. 10, 2003

Related U.S. Application Data
(60) Provisional application No. 60/387,434, filed on Jun. 11, 2002.

(51) Int. Cl. H04J 3/26

(52) U.S. Cl. 370/432; 370/390; 370/338

(57) ABSTRACT

An improved system and method of transmitting messages to multiple destination nodes is provided, in which a message from a source node is addressed to a multicast-broadcast address, and multiple destination node addresses are included in the message header. Destination nodes which successfully receive the transmission calculate a timeslot in which to transmit an acknowledgement message based on the position of their address in the message header. The source node can then provide a retransmission to destination nodes which did not successfully receive the transmission as either a multicast-broadcast or a unicast communication depending on acknowledgement messages received.

This application claims benefit under 35 U.S.C. §119(e) from U.S. provisional patent application serial no. 60/387,434 entitled “System And Method For Multicast Media Access Using Broadcast Transmissions With Multiple Acknowledgments In An Ad-Hoc Communications Network”, filed on Jun. 11, 2002, the entire contents of which is incorporated herein by reference.

### BACKGROUND OF THE INVENTION

1. Field of the Invention

The present invention relates to an improved system and method of transmitting messages to multiple destination nodes in a wireless ad-hoc communication network. More particularly, the present invention relates to a system and method for transmitting messages from a source node to multiple destination nodes using broadcast messaging, followed by unicast messaging to certain destination nodes as determined by acknowledgement messages received by the source node from the destination nodes.

2. Description of the Related Art

Wireless communication networks, such as mobile wireless telephone networks, have become increasingly prevalent over the past decade. These wireless communications networks are commonly referred to as “cellular networks”, because the network infrastructure is arranged to divide the service area into a plurality of regions called “cells”. A terrestrial cellular network includes a plurality of interconnected base stations, or base nodes, that are distributed geographically at designated locations throughout the service area. Each base node includes one or more transceivers that are capable of transmitting and receiving electromagnetic signals, such as radio frequency (RF) communications signals, to and from mobile user nodes, such as wireless telephones, located within the coverage area. The communications signals include, for example, voice data that has been modulated according to a desired modulation technique and transmitted as data packets. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format, which enables a single transceiver at the base node to communicate simultaneously with several mobile nodes within a coverage area.

In recent years, a type of mobile communications network known as an “ad-hoc” network has been developed for use by the military. In this type of network, each mobile node is capable of operating as a base station or router for the other mobile nodes, thus eliminating the need for a fixed infrastructure of base stations. Details of an ad-hoc network are set forth in U.S. Pat. No. 5,943,322 to Mayor, the entire content of which is incorporated herein by reference.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN) and on other networks, such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each being incorporated herein by reference.

In many wireless data network applications, data must be sent to multiple destinations from the same source. Traditionally in ad-hoc wireless networks, this type of communication is achieved by sending multiple transmissions to the various destinations. Unfortunately, each separate transmission consumes valuable bandwidth, therefore increasing the number of destinations increases the consumption of bandwidth. Furthermore, in an ad-hoc wireless network where packets traveling to destinations may take multiple hops to reach a destination, additional bandwidth is used as each transmission at each hop consumes additional bandwidth.

Traditional networks solve the problem of consuming unnecessary bandwidth in transmissions to multiple destinations with broadcast messages. Certain messages intended for multiple recipients are sent once to a special broadcast address. Any nodes associated with the broadcast address that can receive the transmission do so. Unfortunately, this form of broadcast transmission is generally not reliable because the multiple receivers do not acknowledge receipt of the broadcast message. Thus, the sender is not aware of which of the intended recipients actually received the message.

Accordingly, in applications where it is important to confirm that each intended recipient of a broadcast message actually received the message successfully, a new system and method of broadcast transmission is needed. Such a system and method of transmission would provide for acknowledging receipt of the message from each recipient, while at the same time, avoiding unnecessary use of valuable bandwidth resources.

### SUMMARY OF THE INVENTION

An object of the present invention is to provide a system and method for providing a multicast-broadcast to a number of intended destination node addresses.

Another object of the present invention is to provide a system and method for providing a message header for each data packet of a multicast-broadcast communication that includes each intended destination node address.

Still another object of the present invention is to provide a system and method for calculating a timeslot in which each receiving node transmits an acknowledgement message based on the position of their address in the message header.

Still another object of the present invention is to provide a system and method for retransmitting a data packet as a multicast-broadcast where a number of destination nodes failed to receive the data packet.

Still another object of the present invention is to provide a system and method for retransmitting a data packet as a unicast message where a single destination node failed to receive the data packet.

These and other objects are substantially achieved by providing a system and method for sending messages from a source node to multiple destination nodes in a wireless ad-hoc communication network using broadcast messaging, followed by unicast messaging as necessary, to reduce the number of necessary transmissions. Specifically, a source node interprets a destination address as a broadcast address for a data packet communication. The data packet includes a message header including a number of intended destination node addresses, such that each receiving node can reply with an ACK message in a given order based on the message header. The source node can also segment the data packet, allowing each receiving node to reply indicating which segments were not received. The source node can then respond with a retransmission including only segments which failed original transmission. Depending upon the number of intended destinations which indicated failed segment communications, the source node can respond using either a unicast or multicast-broadcast communication. In doing so, the system and method provides a guarantee of message receipt by the destination node as would typically be expected by using only unicast transmissions.

### BRIEF DESCRIPTION OF THE DRAWINGS

The invention will be more readily understood with reference to the attached figures, in which:

FIG. 1 is a block diagram of an example of an ad-hoc wireless communications network employing a system and method for using broadcasts transmissions with multiple acknowledgements according to an embodiment of the present invention;

FIG. 2 is a block diagram illustrating an example of the components of a node employed in the network shown in FIG. 1;

FIG. 3(a) illustrates an example of a multicast-broadcast message transmission in accordance with an embodiment of the present invention;

FIG. 3(b) illustrates an example of the transmission of acknowledgement messages in accordance with an embodiment of the present invention;

FIG. 4(a) is a flow chart that illustrates an example of a multicast-broadcast message transmission in accordance with an embodiment of the present invention; and

FIG. 4(b) is a flow chart that illustrates an example of a multicast-broadcast message retransmission in accordance with an embodiment of the present invention.

In the figures, it will be understood that like numerals refer to like features and structures.

### DETAILED DESCRIPTION OF THE PREFERRED EMBODIMENTS

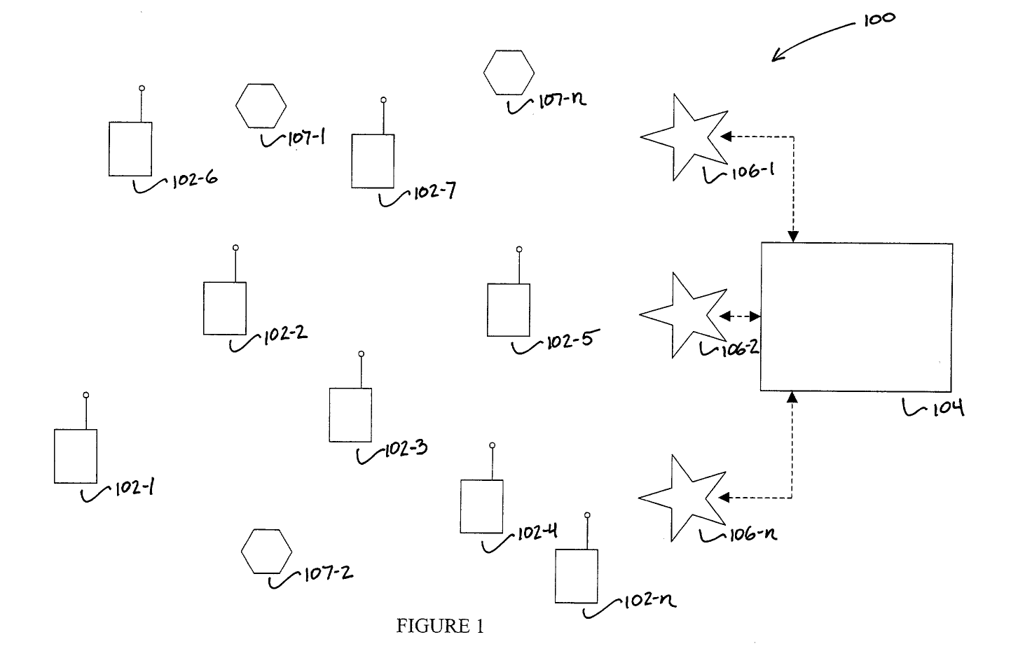

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes or mobile nodes 102), and a fixed network 104 having a plurality of access points 106-1, 106-2, . . . 106-n (referred to generally as nodes or access points 106), for providing the nodes 102 with access to the fixed network 104. The fixed network 104 includes, for example, a core local access network (LAN), and a plurality of servers and gateway routers, to thus provide the nodes 102 with access to other networks, such as other ad-hoc networks, the public switched telephone network (PSTN) and the Internet. The network 100 further includes a plurality of fixed routers 107-1 through 107-n (referred to generally as nodes or fixed routers 107) for routing data packets between other nodes 102, 106 or 107. It is noted that for purposes of this discussion, the nodes discussed above can be collectively referred to as “nodes 102, 106 and 107”, or simply “nodes”.

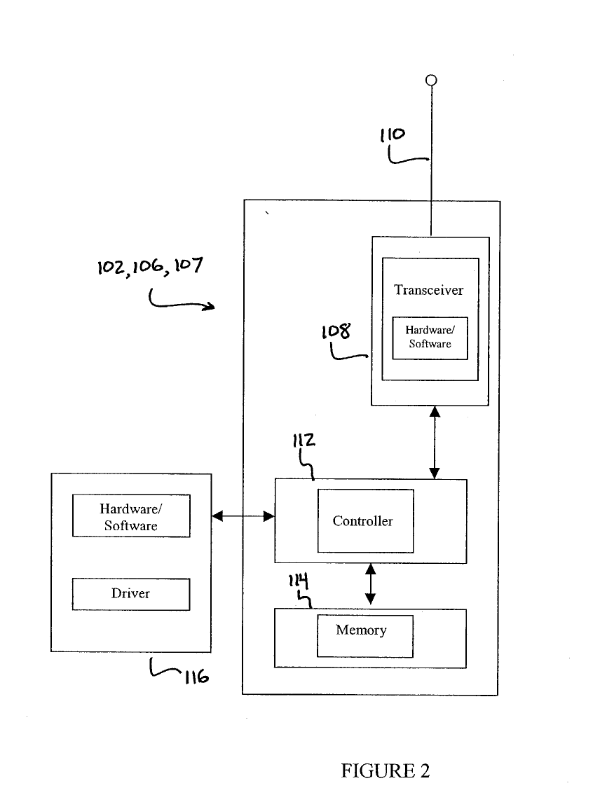

As can be appreciated by one skilled in the art, the nodes 102, 106 and 107 are capable of communicating with each other directly, or via one or more other nodes 102, 106 and 107 operating as a router or routers for data packets being sent between nodes 102, 106 and 107 as described in U.S. Pat. No. 5,943,322 to Mayor, and in U.S. patent application Ser. Nos. 09/897,790, 09/815,157 and 09/815,164, referenced above. Specifically, as shown in FIG. 2, each node 102, 106 and 107 includes a transceiver 108 which is coupled to an antenna 110 and is capable of receiving and transmitting signals, such as packetized data signals, to and from the node 102, 106 or 107, under the control of a controller 112. The packetized data signals can include, for example, voice, data or multimedia.

As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included. Additionally, each node includes the appropriate hardware and software to perform automatic repeat request (ARQ) functions, as set forth in greater detail below.

Each node 102, 106 and 107 further includes a memory 114, such as a random access memory (RAM), that is capable of storing, among other things, routing information pertaining to itself and other nodes in the network 100. The nodes periodically exchange respective routing information, referred to as routing advertisements or routing table information, via a broadcasting mechanism, for example, when a new node enters the network or when existing nodes in the network move. Any of nodes 102, 106 and 107 can broadcast routing table updates, and nearby nodes will only receive the broadcast if within broadcast range (e.g., radio frequency (RF) range) of the broadcasting node 102, 106 or 107. For example, assuming that nodes 102-1, 102-2 and 102-7 are within the RF broadcast range of node 102-6, when node 102-6 broadcasts routing table information, the information is received by nodes 102-1, 102-2 and 102-7. However, if nodes 102-3, 102-4 and 102-5 are beyond the broadcast range, none of those nodes will receive the broadcast directly from node 102-6.

In one example of a broadcast communication implemented in the network 100 of FIG. 1, a broadcast message is transmitted by a node (e.g., node 102, 106 or 107) by sending a request-to-send (RTS) message on the network reservation channel, and any node that hears the RTS will switch to the indicated data channel to receive the message. The benefit of the broadcast message is that the same message can be delivered to every node within transmission range with only one transmission. However, the use of such a broadcast does not notify the sending node as to which nodes heard the message because there is no reply mechanism confirming the receipt of the transmission on the data channel.

In contrast to the method above, to ensure reliable communication, a unicast transmission can be implemented in the network 100 of FIG. 1. Such unicast messages are typically followed up with either an acknowledgement of successful reception (ACK) from the receiver, which informs the sending node that the message was received successfully, or a negative acknowledgement (NACK) where the message must be retransmitted. The NACK message, or lack of an ACK message, indicates that the message was not properly received, including situations where an ACK message was sent, but lost.

The embodiment of the present invention described below provides a system and method of communication that provides the benefits of both broadcast and unicast transmissions by reaching every node within transmission range with a single transmission, and by receiving acknowledgement of the broadcast packet. This system and method will be referred to herein as a “Multicast-Broadcast” and is described in greater detail below.

In a Multicast-Broadcast system and method in accordance with an embodiment of the present invention, the address to which the message is sent is interpreted by the medium access control (MAC) of the sending node as a “special broadcast address”. Thus, the message will be sent with an RTS, followed by the message. According to an embodiment of the invention, all of the intended destinations are listed in the message header in a numerical order. Each intended destination node in turn calculates a time to send the acknowledgement message based upon the numerical order of the destination addresses listed in the message header. Thus, in a simple example, if node address 1, 2, and 3, are the ordered destination nodes listed in the message header and a direct correlation is used, then node 1 will transmit an ACK message in slot one, node 2 will transmit an ACK message in slot 2, and node 3 will transmit an ACK message in slot 3. Addresses 1, 2, and 3, in that numerical order, are presented as examples, and the technique can be expanded to include any number of destination nodes as required by the application.

Therefore in the embodiment of the present invention, the sending node is informed of each of the destination node addresses which successfully received the Multicast-Broadcast message. Any required retransmissions are sent only to the addresses for which an NACK message was received, or an ACK message was not received. The message is preferably retransmitted with the same Multicast-Broadcast mechanism if retransmission is required for two or more nodes. If only one node requires retransmission, then the transmission will be a normal unicast with the traditional RTS-CTS-Message-ACK sequence. This process preferably repeats until acknowledgement messages are received from each intended recipient.

In another embodiment of the present invention, a clear-to-send (CTS) message is utilized to generate the list of destination node addresses in the Multicast-Broadcast message. Before the Multicast-Broadcast message is sent, an RTS message is transmitted, and only destination nodes that are listening and within radio range reply with a CTS message, and are included in the address header. This optimizes the protocol by ensuring that the message is not replayed multiple times due to missing ACK messages from nodes that have moved beyond range before the message was sent. In this manner, the efficiency of the Multicast-Broadcast message is increased even further, particularly where the number of destination nodes for the Multicast-Broadcast message is relatively small. Without such steps, the likelihood of not receiving a broadcast can be high in a busy environment, particularly where the number of destinations is relatively small, such as 2 or 3 destination nodes. As the number of destination nodes increases, the efficiency of the method described above, in which a CTS message is not utilized, increases due to the higher the number of nodes. A higher number of nodes increases the possibility that some nodes will receive the message.

In another embodiment of the present invention, address and channel monitoring can be used, and an intelligent decision can be made based on how busy the network is at a specific time. A network that is not busy is much more likely to successfully receive broadcast messages. In contrast, where a network is very busy the number of nodes from which an ACK message is expected in response to a broadcast message should not be large. Many nodes will not send an ACK message in this situation because they are communicating with other nodes and do not receive the RTS for the broadcast message. This can result in the broadcast message being retried many times. Therefore the nodes that are very busy, as determined by a technique such as address or channel monitoring, should not be expected to reply with an ACK message to the broadcast message. In this case, a unicast message can be used to deliver data. Where full information regarding the state of all nodes is unavailable, the broadcast message can continue to be used.

In another embodiment of the present invention, efficiency is further increased by segmenting packets into packet fragments. After segmenting, cyclic redundancy (CRC) checks can be performed on each packet fragment, rather than whole packets, as described in further detail in a U.S. Patent Application by Pertti O. Alapuranen entitled “Hybrid ARQ for a Wireless Ad-Hoc Network and a Method for Using the Same”, Attorney Docket No. 43665, filed Jan. 21, 2003, the entire content of which is incorporated herein by reference. Thus, if certain packet fragments fail CRC checks while other fragments pass CRC checks, the transmitting node is informed of which fragments should be retransmitted in the ACK, or NACK, message, rather than retransmitting the entire transmission, thereby saving valuable bandwidth. If each of the nodes in the Multicast-Broadcast informs the transmitter which fragments where missed, the transmitting node will preferably retransmit the union of all missed fragments, leaving out the fragments that were safely received by all intended recipients. The receivers of the retransmissions then can take the fragments they need from the retransmission.

In yet another embodiment of the present invention, destinations which require multiple hops in an ad-hoc peer-to-peer network environment can also be addressed using a Multicast-Broadcast message. The Broadcast-Multicast will perform best when the destinations are neighbor nodes with good radio frequency (RF) links between them and the source transmitter. However, a “tree structure” can be formed where nodes are pre-organized into multicast groups that can be addressed using a single multicast. Therefore, if some destinations are multiple hops away, utilizing the method and system of the embodiment of present invention described above can solve this problem. According to an embodiment of the invention, a multicast tree structure is formed in which nodes are pre-organized into multicast groups that can be addressed using a single multicast address with an IAP, or any suitable node, as the head of the tree where the multicast sessions originate. Each node in the tree may have some number of subordinate nodes under it for which it is responsible for relaying these multicast transmissions. In this manner, each time a multicast transmission is received, nodes check to see if they are on that multicast list, or if they have any subordinate nodes in the tree on that list. If either condition is true, they process the message, otherwise the message is discarded. Utilizing this system and method, it is necessary to include only one address in the header, instead of listing each address in the header. The size of the transmission is reduced, along with central processing unit (CPU) overhead and the time required to process multiple addresses.

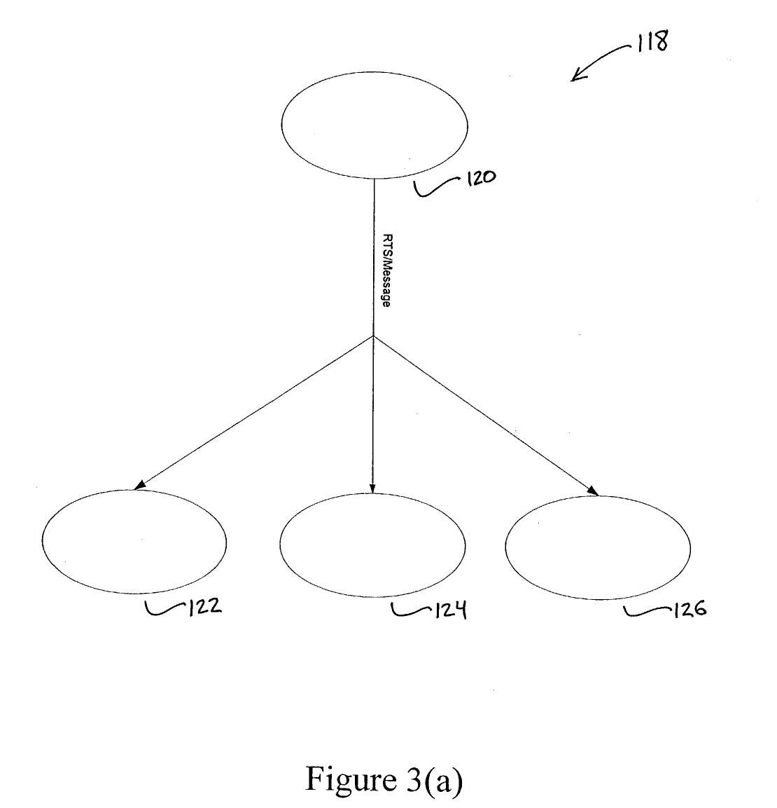

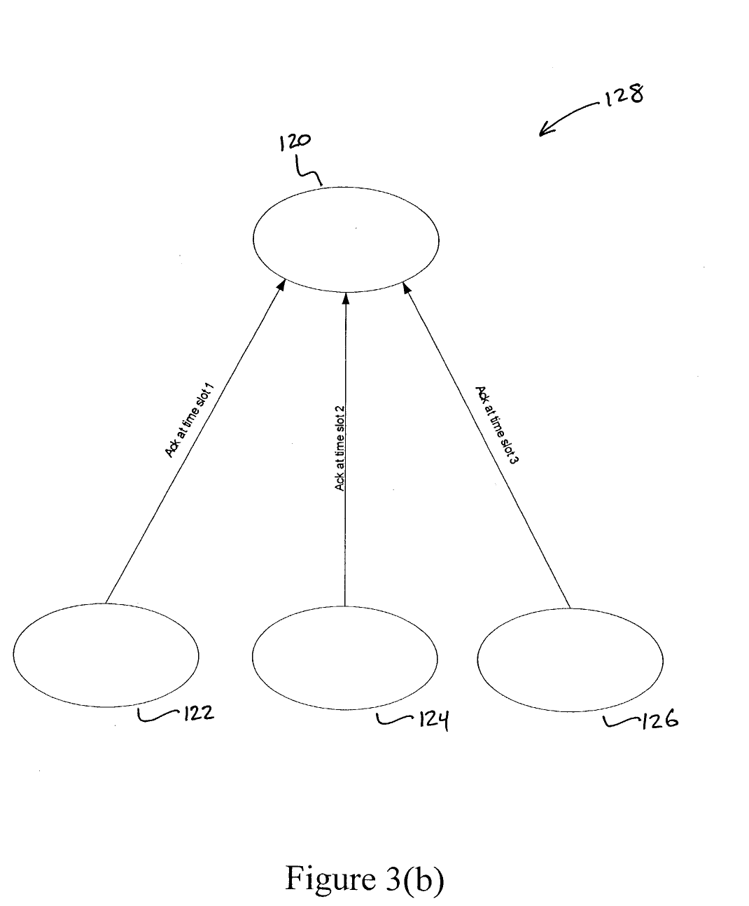

Network 118 of FIG. 3(a) illustrates an example of the transmission of a Multicast-Broadcast message according to an embodiment of the present invention. A transmitting node 120, which can be any of nodes 102, 106 or 107 shown in FIG. 1, sends a Multicast-Broadcast transmission message to a plurality of receivers 122, 124, and 126, which also can be any of nodes 102, 106 and 107. If any of nodes 122, 124, or 126 hears the RTS message, they will prepare to receive the message, however, each may or may not receive the packet successfully. FIG. 3(b) illustrates an example of an instance in which each of the nodes 122, 124, and 126 successfully received the Multicast-Broadcast message. As shown in FIG. 3(b), each of the nodes 122, 124, and 126 successfully received the message, and each node transmits an ACK message in an appropriate time slot calculated by the position of it's MAC address found in the Multicast-Broadcast message header. The transmitter 120 is shown in FIG. 3(b) successfully receiving all of the ACK messages.

However, the following conditions can cause the transmitter 120 of FIGS. 3(a) and 3(b) to consider the transmitted message lost by the node associated with the missing ACK message. For example, if any nodes 122, 124 or 126 missed the original RTS message of FIG. 3(a), or if the RTS failed a CRC check, the transmitter 120 can consider the message lost by the node. Additionally, if any node missed the message, or if the message was corrupted at a node which received the message, as indicated by a failed CRC check, the transmitter can consider the message lost by the node. Still further, if the ACK message was not received by the transmitter 120, or if the ACK message is received by the transmitter 120 but fails a CRC check, the transmitter can consider the message lost by the node. If any of the above conditions occurs, then the message is considered lost, and must be retransmitted to the nodes that missed that message.

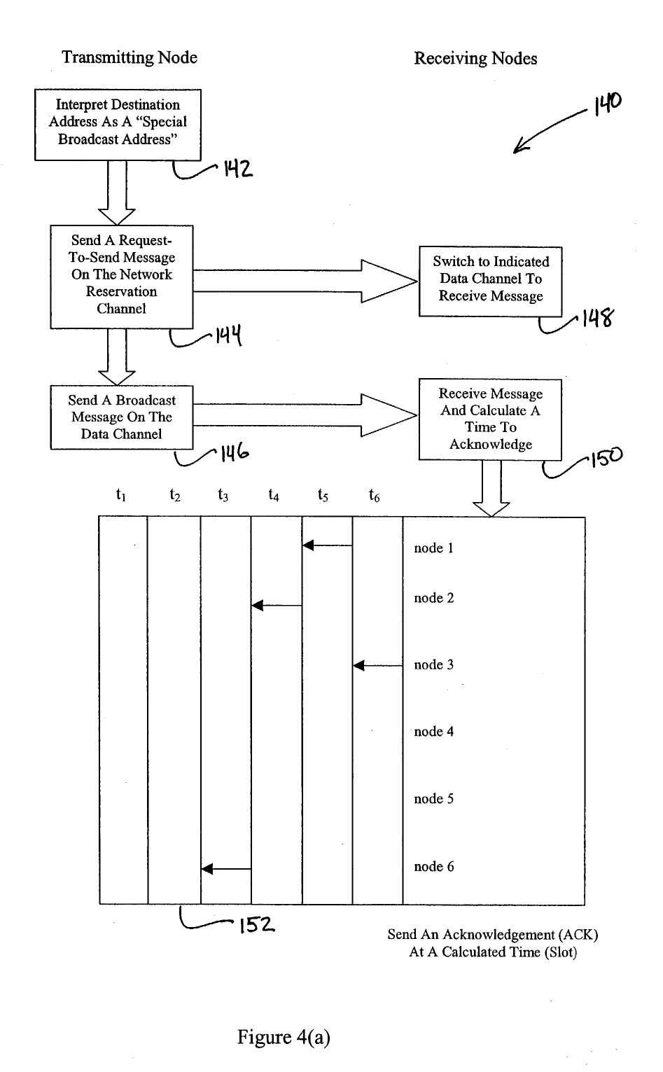

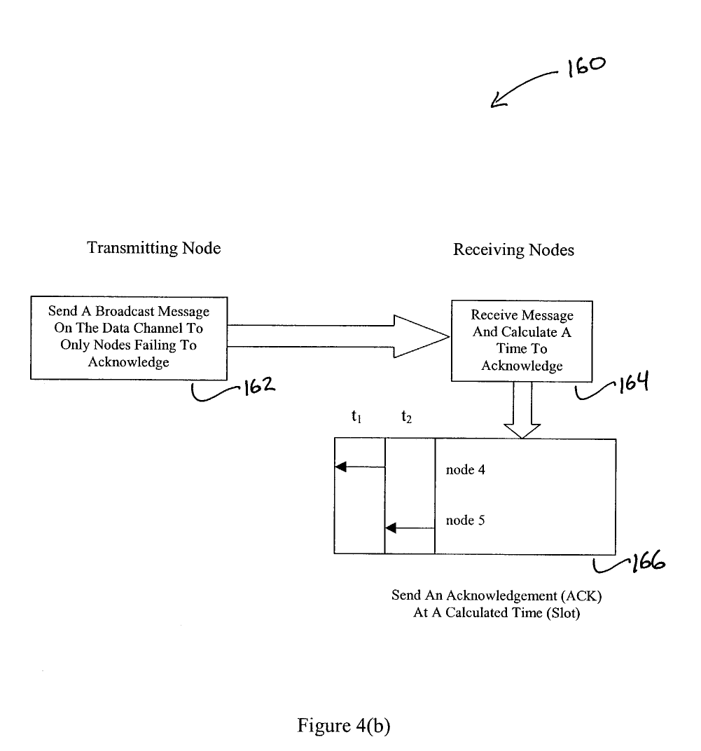

A more detailed example of the transmission of a Multicast-Broadcast message according to an embodiment of the present invention is shown in flow charts 140 and 160 of FIGS. 4(a) and 4(b), respectively. FIGS. 4(a) and 4(b) are flow charts that illustrate an example of a complete multicast-broadcast message transmission in accordance with an embodiment of the present invention. In FIG. 4(a), a transmission between a transmitting node and a number of receivers is initiated at step 142, where the address to which the message is to be sent is interpreted by the medium access control of the sending node as a “special broadcast address”. In step 144, an RTS message is sent on the network reservation channel, and any node that hears the RTS will switch to the indicated data channel to receive the message in step 148. The broadcast message is sent on the data channel in step 146, and includes a message header which, in this example, includes intended destination node addresses for nodes 1, 2, 3, 4, 5 and 6. The destination node addresses are listed in a numerical order in the message header. In this example, the numerical order of destination node addresses is as follows.

position one = node 4
position two = node 5
position three = node 6
position four = node 2
position five = node 1
position six = node 3

The destination nodes, positions, and numerical order noted above are presented as examples only, to illustrate a complete Multicast-Broadcast in a network such as network 100 of FIG. 1. Any number of configurations can be used to achieve the results in accordance with an embodiment of the present invention.

Each node receiving the broadcast message sent on the data channel in step 146, calculates a time to send an acknowledgement message in step 150 based on the numerical order of destination node addresses in the message header. In the example of FIG. 4(a), the calculated time is a direct correlation to destination node address position in the message header, however, any correlation can be used.

In step 152 of flow chart 140, node 1 through node 6 respond with an acknowledgement message at a calculated time. As shown in FIG. 4(a), the period for ACK message response is divided into time slots, which allows each destination node to reply in a specific time slot, without collision between responses. However, in the example of FIG. 4(a), the ACK message from nodes 4 and 5 is shown as failing to reach the transmitting node. The remaining nodes respond in the calculated order, that is, node 6 transmits an ACK message in time slot t₃, node 2 transmits an ACK message in time slot t₄, node 1 transmits an ACK message in time slot t₅, and node 3 transmits an ACK message in time slot t₆.

As noted above however, the ACK message from nodes 4 and 5 fail to reach the transmitting node. Therefore, as shown in flow chart 160 of FIG. 4(b), a retransmission is shown sent only to the destination node addresses for which an ACK message was not received. In FIG. 4(b), the broadcast message is sent on the data channel in step 162, and includes a message header which includes intended destination node addresses for nodes 4 and 5 only. If more intended destination nodes had failed to respond, the message header would include each address which failed to respond. The destination node addresses are listed in the same numerical order in the message header or can be reordered. In this example, the numerical order of destination node addresses remains as noted in the original transmission.

position one = node 4
position two = node 5

Each of nodes 4 and 5 calculates a time to send an acknowledgement message in step 164 as described above, and responds with an acknowledgement message at a calculated time in step 166. This procedure can be repeated until each intended destination node responds. Additionally, where a single node fails to respond, a traditional RTS-CTS-Message-ACK sequence can be used to complete the transmission.

Although only a few exemplary embodiments of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

What is claimed is:

1. A method for data transmission using a multicast-broadcast in an ad-hoc communications network, said network including a plurality of nodes being adapted to transmit and receive signals to and from other nodes in said network, the method comprising:
controlling a sending node to interpret a destination address as a broadcast address for a data packet communication, said data packet having a message header including a plurality of intended destination node addresses, and to transmit said data packet as a broadcast communication; and
controlling at least one of said nodes of said plurality that successfully receives said data packet to communicate an acknowledgement of successful reception (ACK) message to said sending node in an order based on an order in which said plurality of destination node addresses are arranged in said message header, and controlling said sending node to retransmit said data packet to at least one node of said plurality which did not communicate an ACK message to said sending node.

2. A method for data transmission as claimed in claim 1, further comprising:
interpreting the destination address for communicating the data packet as a broadcast address using a media access control (MAC) of said sending node.

3. A method for data transmission as claimed in claim 1, further comprising:
controlling said sending node to include said plurality of intended destination node addresses in said message header of said data packet in a first numerical order.

4. A method for data transmission as claimed in claim 3, further comprising:
controlling at least one successfully receiving node of said plurality to communicate an ACK message to said sending node in an order based on said first numerical order in which said plurality of destination node addresses are arranged in said message header.

5. A method for data transmission as claimed in claim 3, further comprising:
controlling at least one successfully receiving node of said plurality to communicate an ACK message to said sending node in a same order as said first numerical order in which said plurality of destination node addresses are arranged in said message header.

6. A method for data transmission as claimed in claim 1, further comprising:
controlling at least one successfully receiving node of said plurality to calculate a time to communicate said ACK message to said sending node; and
controlling said at least one successfully receiving node to communicate said ACK message to said sending node at said calculated time.

7. A method for data transmission as claimed in claim 1, further comprising:
controlling said sending node to segment said data packet into a plurality of packet segments, and to transmit said segments as said broadcast communication;
controlling at least one receiving node of said plurality to perform a cyclic redundancy check on each said segment, and to communicate an ACK message to said sending node indicating which segments were successfully received and which segments require retransmission based on said cyclic redundancy check; and
controlling said sending node to retransmit said segments that require said retransmission.

8. A method for data transmission as claimed in claim 7, further comprising:
controlling said sending node to retransmit said data packet as a broadcast communication when a plurality of intended destination nodes communicate at least one segment that requires retransmission in said ACK message, said data packet having a message header including said plurality of intended destination node addresses.

9. A method for data transmission as claimed in claim 8, further comprising:
controlling said sending node to retransmit said data packet comprising all segments which were not received by said plurality of intended destination nodes.

10. A method for data transmission as claimed in claim 8, further comprising:
controlling at least one node of said plurality of intended destination nodes to take segments from said retransmission that were not received in said transmission.

11. A method for data transmission as claimed in claim 7, further comprising:
controlling said sending node to retransmit said data packet as a unicast communication when only one said intended destination node communicates at least one segment that requires retransmission in said ACK message, said retransmitted data packet having a message header including said one intended destination node address.

12. A method for data transmission as claimed in claim 11, further comprising:
controlling said sending node to retransmit said data packet comprising all segments which were not received by said one intended destination node.

13. A method for data transmission as claimed in claim 11, further comprising:
controlling said one intended destination node to take segments from said retransmission that were not received in said transmission.

14. A method as claimed in claim 1, wherein said data packet includes forward error correction comprising Viterbi encoding.

15. A method as claimed in claim 1, wherein said data packet includes an error detection code comprising a cyclic redundancy check.

16. A method for data transmission as claimed in claim 1, further comprising:
controlling said sending node to send a request to send (RTS) message to at least one node of said network, and to generate said plurality of intended destination node addresses based on clear to send messages (CTS) received; and
controlling at least one node of said network that receives said RTS message to reply with a CTS message if said node is to receive said message.

17. A method for data transmission as claimed in claim 1, further comprising:
controlling at least one receiving node of said plurality to determine if a subordinate node is an intended destination node address; and
controlling said receiving node to route said broadcast communication to said subordinate node where said subordinate node is an intended destination node address.

18. A method for data transmission as claimed in claim 17, wherein said receiving node and said at least one subordinate node comprise a multi-hop network.

19. A method for data transmission as claimed in claim 1, further comprising:
controlling said sending node to monitor activity levels on at least one of an address and channel of said network for use in said communication of said data packet.

20. A system for data transmission using a multicast-broadcast in an ad-hoc communications network, said network including a plurality of nodes being adapted to transmit and receive signals to and from other nodes in said network, the system comprising:
a first node, adapted to interpret a destination address as a broadcast address for a data packet communication, said data packet having a message header including a plurality of intended destination node addresses, and to transmit said data packet as a broadcast communication; and
at least one node of said plurality which, upon successful receipt of said data packet, is adapted to communicate an acknowledgement of successful reception (ACK) message to said first node in an order based on an order in which said plurality of destination node addresses are arranged in said message header, and said first node being further adapted to retransmit said data packet to at least one node of said plurality which did not communicate an ACK message to said sending node.

21. A system for data transmission as claimed in claim 20, wherein:
said first node is adapted to include said plurality of intended destination node addresses in said message header of said data packet in a first numerical order.

22. A system for data transmission as claimed in claim 21, wherein:
at least one receiving node of said plurality is adapted to communicate an ACK message to said first node in an order based on said first numerical order in which said plurality of destination node addresses are arranged in said message header.

23. A system for data transmission as claimed in claim 21, wherein:
at least one receiving node of said plurality is adapted to communicate an ACK message to said first node in a same order as said first numerical order in which said plurality of destination node addresses are arranged in said message header.

24. A system for data transmission as claimed in claim 20, wherein:
at least one receiving node of said plurality is adapted to calculate a time to communicate said ACK message to said first node, and to communicate said ACK message to said first node at said calculated time.

25. A system for data transmission as claimed in claim 20, wherein:
said first node is adapted to segment said data packet into a plurality of packet segments, and to transmit said segments as said broadcast communication; and
at least one receiving node of said plurality is adapted to perform a cyclic redundancy check on each said segment, and to communicate an ACK message to said first node indicating which segments were successfully received and which segments require retransmission based on said cyclic redundancy check, and said first node is further adapted to retransmit said segments that require said retransmission.

26. A system for data transmission as claimed in claim 25, wherein:
said first node is adapted to retransmit said data packet as a broadcast communication when a plurality of intended destination nodes communicate at least one segment that requires retransmission in said ACK message, said data packet having a message header including said plurality of intended destination node addresses.

27. A system for data transmission as claimed in claim 26, wherein:
said first node is adapted to retransmit said data packet comprising all segments which were not received by said plurality of intended destination nodes.

28. A system for data transmission as claimed in claim 26, wherein:
at least one node of said plurality of intended destination nodes is adapted to take segments from said retransmission that were not received in said transmission.

29. A system for data transmission as claimed in claim 25, wherein:
said first node is adapted to retransmit said data packet as a unicast communication when only one said intended destination node communicates at least one segment that requires retransmission in said ACK message, said retransmitted data packet having a message header including said one intended destination node address.

30. A system for data transmission as claimed in claim 29, wherein:
said first node is adapted to retransmit said data packet comprising all segments which were not received by said one intended destination node.

31. A system for data transmission as claimed in claim 29, wherein:
said one intended destination node is adapted to take segments from said retransmission that were not received in said transmission.

32. A system for data transmission as claimed in claim 20, wherein:
said first node is adapted to send a request to send (RTS) message to at least one node of said network, and to generate said plurality of intended destination node addresses based on clear to send messages (CTS) received; and
at least one node of said network that receives said RTS message is adapted to reply with a CTS message if said node is to receive said message.

33. A system for data transmission as claimed in claim 20, wherein:
at least one receiving node of said plurality is adapted to determine if a subordinate node is an intended destination node address, and to route said broadcast communication to said subordinate node where said subordinate node is an intended destination node address.

34. A system for data transmission as claimed in claim 33, wherein said receiving node and said at least one subordinate node comprise a multi-hop network.

35. A computer-readable medium of instructions, adapted to control data transmission using a multicast-broadcast in an ad-hoc communications network, said network including a plurality of nodes being adapted to transmit and receive signals to and from other nodes in said network, comprising:
a first set of instructions, adapted to control a first node to interpret a destination address as a broadcast address for a data packet communication, said data packet having a message header including a plurality of intended destination node addresses, and to transmit said data packet as a broadcast communication;
a second set of instructions, adapted to control at least one node of said plurality which, upon successful receipt of said data packet, is adapted to communicate an acknowledgement of successful reception (ACK) message to said first node in an order based on an order in which said plurality of destination node addresses are arranged in said message header; and
a third set of instructions, adapted to control said first node to retransmit said data packet to at least one node of said plurality which did not communicate an ACK message to said sending node.

36. A computer-readable medium of instructions, adapted to control data transmission as claimed in claim 35, wherein:
said first set of instructions is adapted to control said first node to include said plurality of intended destination node addresses in said message header of said data packet in a first numerical order.

37. A computer-readable medium of instructions, adapted to control data transmission as claimed in claim 36, wherein:
said second set of instructions is adapted to control at least one receiving node of said plurality to communicate an ACK message to said first node in an order based on said first numerical order in which said plurality of destination node addresses are arranged in said message header.

38. A computer-readable medium of instructions, adapted to control data transmission as claimed in claim 36, wherein:
said second set of instructions is adapted to control at least one receiving node of said plurality to communicate an ACK message to said first node in a same order as said first numerical order in which said plurality of destination node addresses are arranged in said message header.

39. A computer-readable medium of instructions, adapted to control data transmission as claimed in claim 35, wherein:
said second set of instructions is adapted to control at least one receiving node of said plurality to calculate a time to communicate said ACK message to said first node, and to communicate said ACK message to said first node at said calculated time.

40. A computer-readable medium of instructions, adapted to control data transmission as claimed in claim 35, wherein:
said first set of instructions is adapted to control said first node to segment said data packet into a plurality of packet segments, and to transmit said segments as said broadcast communication;
said second set of instructions is adapted to control at least one receiving node of said plurality to perform a cyclic redundancy check on each said segment, and to communicate an ACK message to said first node indicating which segments were successfully received and which segments require retransmission based on said cyclic redundancy check; and
said third set of instructions is adapted to control said first node to retransmit said segments that require said retransmission.

41. A computer-readable medium of instructions, adapted to control data transmission as claimed in claim 40, wherein:
said third set of instructions is adapted to control said first node to retransmit said data packet as a broadcast communication when a plurality of intended destination nodes communicate at least one segment that requires retransmission in said ACK message, said data packet having a message header including said plurality of intended destination node addresses.

42. A computer-readable medium of instructions, adapted to control data transmission as claimed in claim 41, wherein:
said third set of instructions is adapted to control said first node to retransmit said data packet comprising all segments which were not received by said plurality of intended destination nodes.

43. A computer-readable medium of instructions, adapted to control data transmission as claimed in claim 41, wherein:
said second set of instructions is adapted to control at least one node of said plurality of intended destination nodes to take segments from said retransmission that were not received in said transmission.

44. A computer-readable medium of instructions, adapted to control data transmission as claimed in claim 40, wherein:
said first set of instructions is adapted to control said first node to retransmit said data packet as a unicast communication when only one said intended destination node communicates at least one segment that requires retransmission in said ACK message, said retransmitted data packet having a message header including said one intended destination node address.

45. A computer-readable medium of instructions, adapted to control data transmission as claimed in claim 44, wherein:
said third set of instructions is adapted to control said first node to retransmit said data packet comprising all segments which were not received by said one intended destination node.

46. A computer-readable medium of instructions, adapted to control data transmission as claimed in claim 44, wherein:
said second set of instructions is adapted to control said one intended destination node to take segments from said retransmission that were not received in said transmission.

47. A computer-readable medium of instructions, adapted to control data transmission as claimed in claim 35, wherein:
said first set of instructions is adapted to control said first node to send a request to send (RTS) message to at least one node of said network, and to generate said plurality of intended destination node addresses based on clear to send messages (CTS) received; and
said second set of instructions is adapted to control at least one node of said network that receives said RTS message to reply with a CTS message if said node is to receive said message.

48. A computer-readable medium of instructions, adapted to control data transmission as claimed in claim 35, further comprising:
a fourth set of instructions, adapted to control at least one receiving node of said plurality to determine if a subordinate node is an intended destination node address, and to route said broadcast communication to said subordinate node where said subordinate node is an intended destination node address.

49. A computer-readable medium of instructions, adapted to control data transmission as claimed in claim 48, wherein:
said receiving node and said at least one subordinate node comprise a multi-hop network.
